(19) United States
(12) Patent Application Publication
(10) Pub. No.: US 2009/0014028 A1
(43) Pub. Date: Jan. 15, 2009

(54) METHOD OF CLEANING SUBSTRATES AND SUBSTRATE CLEANER

(75) Inventors: Yusaku Hirota, Tokyo (JP); Itaru Kanno, Tokyo (JP); Hiroshi Morita, Tokyo (JP); Junichi Ida, Tokyo (JP)

Correspondence Address: MCDERMOTT WILL & EMERY LLP, 600 13TH STREET, N.W., WASHINGTON, DC, 20005-3096, US

(73) Assignees: RENESAS TECHNOLOGY CORP.; KURITA WATER INDUSTRIES LTD.

(21) Appl. No.: 12/170,823

(22) Filed: Jul. 10, 2008

(30) Foreign Application Priority Data
Jul. 12, 2007 (JP) 2007-183234 (P)

(51) Int. Cl. B08B 3/10; B08B 3/12; B08B 3/08

(52) U.S. Cl. 134/1.3; 134/1; 134/30; 134/95.1; 134/95.3; 134/95.2

(57) ABSTRACT

There is provided a method of efficiently cleaning substrates without damaging a fine pattern formed thereon. It is a method of cleaning one or more substrates in a system processing one or more substrates as one batch by dipping one or more substrates as one batch, including the steps of: immersing one or more substrates as one batch in a wet etching solution; ultrasonically cleaning one or more substrates as one batch; and drying one or more substrates as one batch. The step of ultrasonically cleaning employs a cleaning solution having a gas dissolved therein to have a degree of saturation of 60% to 100% at an atmospheric pressure, and an ultrasonic wave having a frequency of at least 500 kHz and an energy of 0.02 W/cm² to 0.5 W/cm².

### BACKGROUND OF THE INVENTION

1. Field of the Invention

The present invention relates generally to cleaning substrates, and particularly to methods of cleaning semiconductor substrates, liquid crystal substrates, disk substrates, photomasks and other similar substrates to remove contaminants adhering to their surfaces, and cleaners for such substrates.

2. Description of the Background Art

Conventionally, cleaning methods that utilize ultrasonic waves or two-phase flow jet or similar physical force have been used as a technique to remove fine particles on semiconductor substrates (see Japanese Patent Laying-open No. 2001-345301). While these methods all have high cleaning effects and are thus excellent cleaning methods, they are accompanied by a trade-off between removal of foreign matters and damage to fine patterns. In other words, attempting to achieve a higher cleaning effect results in increased damage to fine patterns. As such, preventing damage to fine patterns entails reduced detergency, failing to sufficiently effectively remove foreign matters. Furthermore, two-phase flow jet is used in a system processing wafers, one at a time, and cannot be applied to cleaning wafers by dipping them.

FIG. 8 shows a configuration of a cleaner in a system processing a batch by dipping it as an example of a conventional semiconductor substrate cleaner. This cleaner can process a maximum for example of 25 or 50 semiconductor substrates as one batch at a time, and as a basic configuration, it has a bath for processing with a wet etching solution (a bath 4 for processing with a chemical), a water cleaning bath 25, and a dryer unit 9, and includes a robot (not shown) transferring the substrates.

The bath for processing with the wet etching solution (bath 4 for processing with the chemical) is provided with an ultrasonic wave oscillator 8 (an oscillation plate), and generally includes a wet etching solution circulation and filtration system (not shown) including a particle removal filter, a temperature adjuster, a pump, and the like. In the FIG. 8 example, the water cleaning bath is also provided with ultrasonic wave oscillator 8 (or the oscillation plate). Ultrasonic wave oscillator 8 provided to the bath for processing with the wet etching solution (bath 4 for processing with the chemical) and the like has a frequency of at least 500 kHz, and normally, that in a range of 750 to 950 kHz is used. Furthermore, it outputs an ultrasonic wave having an energy generally in a range of 0.3 to 3 W/cm².

A substrate 6 is cleaned in a method, as follows: Initially, one batch of substrates 6 are immersed in a wet etching solution contained in the bath for processing with the wet etching solution (bath 4 for processing with a chemical). The wet etching solution is for example a solution of a mixture of ammonia, oxygenated water, and water (APM). During the immersion, ultrasonic wave oscillator 8 exposes substrates 6 to an ultrasonic wave. Substrates 6 are then immersed in water cleaning bath 25 supplied with pure water, and simultaneously, substrates 6 are exposed to an ultrasonic wave. Normally, the pure water used in the water cleaning is ultrapure water degassed to substantially expel gas dissolved therein, or ultrapure water containing a small amount of nitrogen gas, and generally it has a temperature equal to that of a clean room, i.e., around 23° C. After substrates 6 are cleaned with water for a desired period of time, substrates 6 are moved to dryer unit 9 and dried therein, and a cleaning process thus completes.

### SUMMARY OF THE INVENTION

However, when such conventional cleaner processes with a wet etching solution a substrate having a fine pattern formed thereon, or exposes such substrate to an ultrasonic wave while the substrate is cleaned with water, the fine pattern is easily damaged. As such, in reality, when a substrate having a fine pattern formed thereon is cleaned, it cannot be exposed to a sufficient ultrasonic wave, resulting in a significantly reduced particle removal effect. Furthermore, an ultrasonic wave having a controlled energy is provided to attempt to eliminate damage to a fine pattern on a substrate. However, reducing an ultrasonic wave's energy to an extent allowing the substrate to have no damage results in particle removal performance reduced to an extent at which there is not ultrasonic wave exposure. As such, avoiding damage to fine patterns and improving particle removal efficiency are mutually incompatible, resulting in reduced yields.

The present invention contemplates a method of cleaning substrates efficiently without damaging fine patterns formed thereon. Furthermore, the present invention also contemplates a substrate cleaner that implements such method.

The present invention in an embodiment provides a method of cleaning one or more substrates in a system processing one or more substrates as one batch by dipping one or more substrates as one batch, including the steps of: immersing one or more substrates as one batch in a wet etching solution; ultrasonically cleaning one or more substrates as one batch; and drying one or more substrates as one batch, the step of ultrasonically cleaning employing a cleaning solution having a gas dissolved therein to have a degree of saturation of 60% to 100% at an atmospheric pressure, and an ultrasonic wave having a frequency of at least 500 kHz and an energy of 0.02 W/cm² to 0.5 W/cm².

The present invention in another embodiment provides a method of cleaning substrates, one at a time, including the steps of: applying a wet etching solution to a single substrate while spinning the substrate; applying a cleaning solution to the substrate while spinning the substrate; and drying the substrate, the step of applying the cleaning solution employing a cleaning solution having a gas dissolved therein to have a degree of saturation of 60% to 100% at an atmospheric pressure, the cleaning solution being exposed to an ultrasonic wave before the step of applying the cleaning solution, the ultrasonic wave having a frequency of at least 1 MHz and an energy of at most 10 W.

The present invention can prevent damage to a fine pattern and also provide significantly efficient cleaning.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows a method of preparing a cleaning solution used in the present invention.

FIG. 2 shows how a degree of saturation of hydrogen dissolved in a cleaning solution used in the present invention affects at what rate fine particles are removed and how many patterns are damaged.

FIG. 3 shows in accordance with the present invention how a level in energy of an ultrasonic wave affects at what rate fine particles are removed and how many patterns are damaged.

FIG. 4 shows in accordance with the present invention how a cleaning solution's temperature affects at what rate fine particles are removed and how many patterns are damaged.

FIG. 5 shows a configuration of a substrate cleaner in a system processing a batch by dipping it in accordance with the present invention.

FIG. 6 shows another configuration of a substrate cleaner in a system processing a batch by dipping it in accordance with the present invention.

FIG. 7 shows a configuration of a substrate cleaner in a system processing wafers, one at a time, in accordance with the present invention.

FIG. 8 shows a configuration of a cleaner in a system processing a batch by dipping it, as conventional.

### DESCRIPTION OF THE PREFERRED EMBODIMENTS

### Method of Cleaning Substrate

The present method of cleaning substrates, in a system processing a batch by dipping it, ultrasonically cleans the substrates with a cleaning solution having a gas dissolved therein to have a degree of saturation of 60% to 100% at atmospheric pressure, and an ultrasonic wave having a frequency of at least 500 kHz and an energy of 0.02 W/cm² to 0.5 W/cm². If a degree of saturation of a dissolved gas is defined to indicate a ratio relative to a concentration that the dissolved gas has when the dissolved gas saturates at atmospheric pressure, employing a cleaning solution having a gas dissolved therein to have a degree of saturation of at least 60% to ultrasonically clean a substrate, and applying an ultrasonic wave for exposure that is optimized in frequency and energy, can achieve two effects, i.e., reducing or preventing damage to a fine pattern formed on the substrate, and cleaning the substrate more efficiently. The present cleaning method can efficiently clean a semiconductor substrate having a fine pattern having a line width for example of at most 0.5 μm, and prevent the fine pattern from collapsing. The present method of cleaning substrates, in the system processing a batch by dipping it, includes the steps of: immersing one or more substrates as one batch in a wet etching solution; ultrasonically cleaning one or more substrates as one batch; and drying one or more substrates as one batch.

Conventionally, to maximally prevent silicon configuring a semiconductor substrate from being oxidized while it is cleaned, a cleaning solution formed of degassed ultrapure water is used. However, if the cleaning solution has a gas dissolved therein in a small amount, the substrate will have a fine pattern significantly damaged as it is exposed to an ultrasonic wave. The present invention employs a cleaning solution having a gas dissolved therein to have a degree of saturation preferably of at least 60%, more preferably at least 70%, still more preferably at least 80% to reduce or prevent damage to a fine pattern.

An ultrasonic wave having a lower frequency more readily damages a surface of an object to be cleaned. Accordingly, in cleaning a microfabricated substrate, a frequency desirably of at least 500 kHz, more desirably at least 750 kHz is used. Furthermore, preferably the ultrasonic wave has an energy of at least 0.02 W/cm², more preferably at least 0.05 W/cm² to more effectively remove foreign matters. On the other hand, in terms of reducing or preventing damage to a pattern, at most 0.5 W/cm² is preferable, and at most 0.2 W/cm² is more preferable. Values lower than 0.02 W/cm² do reduce or prevent damage, however, there is a tendency to remove foreign matters less effectively. Values larger than 0.5 W/cm² allow foreign matters to be sufficiently effectively removed, however, there is a tendency to damage the pattern more.

The present method of cleaning substrates, in a system processing them, one at a time, includes the step of cleaning with a cleaning solution that has a gas dissolved therein to have a degree of saturation of 60% to 100% at atmospheric pressure and is exposed to an ultrasonic wave having a frequency of at least 1 MHz and an energy of at most 10 W before the cleaning solution is applied to the substrate with the substrate spun. The cleaning solution having a gas dissolved therein to have a degree of saturation of at least 60% and an ultrasonic wave having its frequency and energy optimized can reduce or prevent damage to a fine pattern on a substrate and allow the substrate to be cleaned more efficiently. Thus the present cleaning method can efficiently clean a semiconductor substrate having a fine pattern for example of a line having a width of at most 0.5 μm, and prevent the fine pattern from collapsing. The present method of cleaning substrates, in the system processing them, one at a time, includes the steps of: applying a wet etching solution to a single substrate while spinning the substrate; applying a cleaning solution to the substrate while spinning the substrate; and drying the substrate.

The cleaning solution has the gas dissolved therein to have a degree of saturation preferably of at least 60%, more preferably at least 70%, still more preferably at least 80% to reduce or prevent damage to a fine pattern. Furthermore, an ultrasonic wave having a lower frequency more readily damages a surface of an object to be cleaned. Accordingly, in cleaning a microfabricated substrate, a frequency desirably of at least 1 MHz, more desirably at least 1.5 MHz is used. Furthermore, the ultrasonic wave applied to the cleaning solution before it is applied while the substrate is spun has an energy preferably of at most 10 W, more preferably at most 5 W to reduce or prevent damage to the pattern.

The system processing substrates in a batch by dipping it, and that processing substrates, one at a time, commonly have the following points: The systems employ the cleaning solution that has a temperature preferably of at least 30° C., more preferably at least 40° C. to reduce or prevent damage to a fine pattern. The effect of removing foreign matters is not impaired by increasing the cleaning solution in temperature. However, the cleaning solution having high temperature has an increased tendency to collapse the fine pattern. Accordingly, at most 90° C. is preferable and at most 80° C. is more preferable. The cleaning solution may be heated by any method: it may be heated after or before hydrogen gas or a similar gas to be dissolved is supplied. Whichever one of the approaches may be taken, the cleaning solution's temperature affects the hydrogen gas's saturation solubility, and accordingly, it is desirable that hydrogen gas be supplied in an amount adjusted considering a concentration that the hydrogen dissolved has when it saturates for a set temperature. Furthermore, if a substrate having a relatively firm fine pattern thereon is cleaned, the ultrasonic wave can be set to have large energy to more effectively remove foreign matters, and it is not necessary to particularly increase the cleaning solution in temperature. In contrast, if a substrate having a significantly fragile pattern fabricated thereon is cleaned, it is desirable that the ultrasonic wave have an energy set to be low and that the cleaning solution have a temperature set to be high.

Ultrasonic cleaning is considered to have the following mechanism: An ultrasonic wave's energy forms cavitations (or small air babbles) in a cleaning solution, and when the small babbles disappear, local energy is provided, which removes particles from a substrate. If the cleaning solution has a gas dissolved therein in an increased amount, more cavitations are caused and higher detergency is provided. In dissolving a gas in the cleaning solution, the gas may be supplied in any method, although, to control the concentration of the gas to be dissolved, it is desirable to once degas the solvent to remove unwanted gas therefrom and subsequently use a dissolution membrane to supply a required amount of gas to be dissolved.

The gas to be dissolved can be a gas selected from the group consisting of hydrogen gas (H₂), nitrogen gas (N₂), oxygen gas (O₂) and carbon dioxide gas (CO₂) or a gaseous mixture of at least two thereof. In particular, hydrogen gas can provide high detergency. How a fine pattern is damaged depends on the ultrasonic wave's energy and the cavitations' energy, and when a cleaning solution containing hydrogen gas is used, cavitations of low energy are formed, which is considered to less tend to cause damage to the fine pattern. If an ultrasonic wave having high energy is applied, the ultrasonic wave's energy (or oscillation energy) readily causes damage to a fine pattern, and accordingly, the ultrasonic wave's energy should be at most a threshold value.

The cleaning solution is preferably a solution obtained by dissolving a gas in ultrapure water, since such solution contains less foreign matters. Furthermore the cleaning solution is preferably a solution of a mixture of a solution obtained by dissolving a gas in ultrapure water and a wet etching solution, since such solution less damages a fine pattern and can contribute to high particle removal performance. The bath for processing with APM or a similar wet etching solution generally adopts a circulation and filtration system, and it is difficult to control hydrogen gas in concentration. As such, dissolving hydrogen gas in the bath for processing with the wet etching solution, and ultrasonically cleaning a substrate, do not readily provide high particle removal performance without damaging a fine pattern.

The substrates are cleaned for a period of time, which varies with the ultrasonic wave's condition, the cleaning solution's temperature and the like. Generally, a period of at least 2 minutes is preferable, since such period allows more efficient cleaning. If a substrate has a collapsible fine pattern thereon, it is cleaned preferably for at most 15 minutes.

The wet etching solution can be the aforementioned APM (a solution of a mixture of ammonia, oxygenated water, and water), HPM (a solution of a mixture of hydrochloric acid, oxygenated water, and water), SPM (a solution of a mixture of sulfuric acid, oxygenated water, and water), HF (hydrofluoric acid), BHF (buffered hydrofluoric acid), or the like. APM etches a Si substrate to remove particles from the substrate. HPM dissolves and thus removes metallic contaminants. SPM dissolves and thus removes resist and other similar organic matters and metallic contaminants. Furthermore, HF and BHF etch oxide film.

### Substrate Cleaner

The present substrate cleaner implements a cleaning method including the steps of: immersing one or more substrates as one batch in a wet etching solution; ultrasonically cleaning one or more substrates as one batch; and drying one or more substrates as one batch, and it includes for example a bath for immersing one or more substrates as one batch therein for processing the substrate(s) with the wet etching solution, an ultrasonic cleaning bath and a dryer unit, and in the step of ultrasonically cleaning (in the ultrasonic cleaning bath or the like), a cleaning solution having a gas dissolved therein to have a degree of saturation of 60% to 100% at atmospheric pressure is used and an ultrasonic wave having a frequency of at least 500 kHz and an energy of 0.02 W/cm² to 0.5 W/cm², preferably 0.05 W/cm² to 0.2 W/cm² is applied. Furthermore the present substrate cleaner in another manner performs in a single container the steps of immersing the substrate(s) in the wet etching solution and ultrasonically cleaning the substrate(s). This manner is preferable, as it allows the steps of immersing the substrate(s) in the wet etching solution and ultrasonically cleaning the substrate(s) to be done without interruption, i.e., without exposing the substrate(s) to air, and can thus reduce or prevent particles once removed from and again adhering to the substrate(s) and also allows the cleaner to be reduced in size.

More specifically, FIG. 5 shows a configuration of a substrate cleaner in a system processing a batch by dipping it. This substrate cleaner can process a maximum for example of 25 or 50 semiconductor substrates as one batch at a time, and as a basic configuration, it has a bath for processing with a wet etching solution (bath 4 for processing with a chemical), an ultrasonic cleaning bath (a bath 7 for processing with pure water having a gas dissolved therein), and a dryer unit 9, and includes a robot (not shown) transferring substrates 6 for each step. Bath 7 is provided with ultrasonic wave oscillator 8, and a hydrogen water supply unit 11 that degasses pure water to be supplied and mixes hydrogen gas generated by electrolysis of water into the degassed pure water and a heater unit 12 increasing the pure water in temperature (or heating it) are connected thereto. Note that generating hydrogen is not limited to electrolysis of water; hydrogen may be supplied externally from a cylinder (not shown).

In this cleaner initially one or more substrates 6 of one batch is/are immersed in APM (a solution of a mixture of ammonia, oxygenated water, and water) contained in bath 4 and serving as a wet etching solution for processing with the chemical. Substrate(s) 6 are then immersed in bath 7 receiving pure water supplied from a pure water supply unit 10, mixed with hydrogen gas by hydrogen water supply unit 11, and controlled by heater unit 12 to have a desired temperature. While substrate(s) 6 are cleaned, ultrasonic wave oscillator 8 exposes substrate(s) 6 to an ultrasonic wave. After substrate(s) 6 are processed for a desired period of time, substrate(s) 6 are moved to dryer unit 9 and dried therein to complete a series of steps of a process.

The APM acts to slightly etch a variety of materials (Si, SiO₂, SiN and the like) of a surface of a semiconductor substrate, and acts to weaken the adhesive strength of particles adhering to the substrate. Subsequently, the substrate(s) are exposed continuously to the ultrasonic wave in the pure water having the gas dissolved therein, to efficiently remove particles on the substrate(s). The pure water has the gas dissolved therein to have a degree of saturation (i.e., a ratio relative to a concentration that the dissolved gas has when the dissolved gas saturates at atmospheric pressure) preferably of at least 60%, and it can also be used when it is supersaturated. The pure water having the gas dissolved therein to have a degree of saturation lower than 60% provides a low ability to remove particles. The ultrasonic wave preferably has a frequency of at least 500 kHz. A frequency lower than 500 kHz tends to readily damage a fine pattern formed on a substrate. A high frequency of at least 750 kHz, which is referred to as “megasonic,” is more preferable, as damage can further be reduced or prevented.

The ultrasonic wave per unit area (i.e., for the oscillation plate's area) has an energy set to be preferably 0.02 to 0.5 W/cm², more preferably 0.05 to 0.2 W/cm². An ultrasonic wave having excessively high energy has an increased tendency to damage a fine pattern. An ultrasonic wave having small energy contributes to a reduced ability to remove particles. The cleaning solution has a temperature set preferably at 30 to 90° C., more preferably 40 to 80° C. The cleaning solution having a temperature set at 30 to 90° C. can reduce or prevent damage to a fine pattern and remove particles more efficiently. Setting the dissolved gas's concentration, the ultrasonic wave's frequency and energy, and the cleaning solution's temperature, as appropriate, allows particles to be removed highly efficiently without damaging a fine pattern, as has been conventionally unachievable.

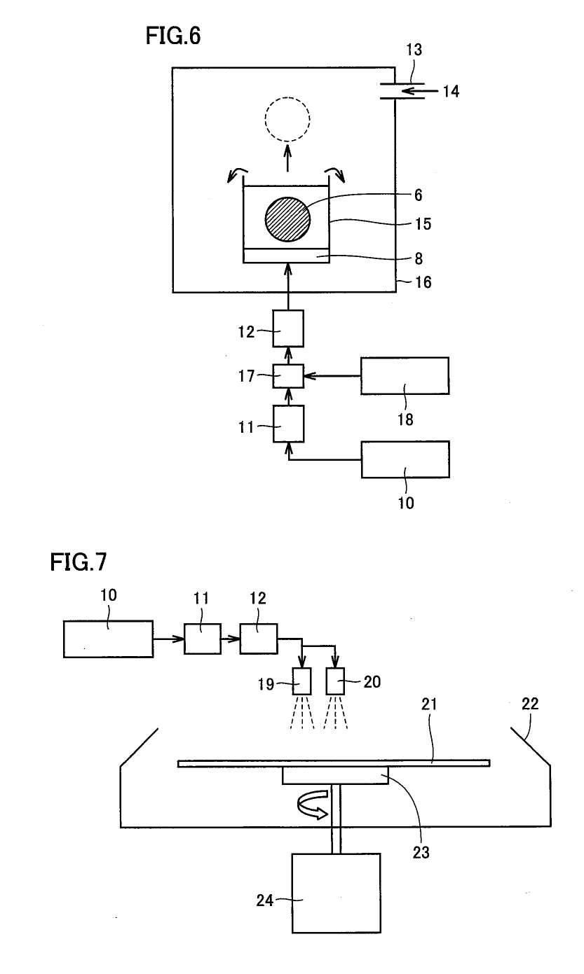

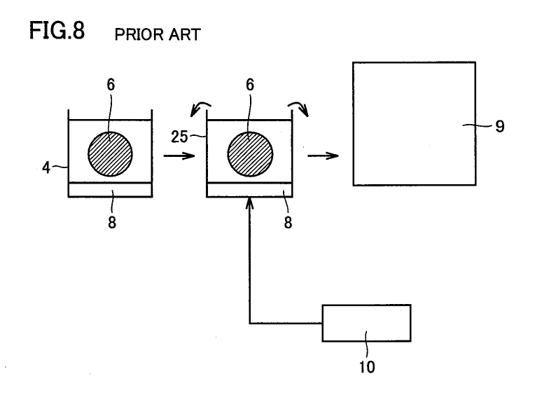

FIG. 6 shows another manner of a substrate cleaner in a system processing a batch by dipping it. This substrate cleaner is a cleaner with a single bath that is used to process a batch by dipping it, and is characterized in that it includes a single processing bath 15 to apply a wet etching solution to the batch, clean the batch with a cleaning solution, and dry the batch without interruption and that this is done in a sealed chamber 16. The cleaner performs a process having a flow identical to that performed by the cleaner previously described, and in the final step or the step of drying, sealed chamber 16 is internally supplied with vapor 14 of isopropyl alcohol (IPA) through a gas supply port 13 and substrate(s) 6 are drawn out of single processing bath 15, as indicated in the figure by a dotted line, or the solution is exhausted to dry substrate(s) 6. Single processing bath 15 is provided with ultrasonic wave oscillator 8, and hydrogen water supply unit 11 mixing hydrogen gas into pure water and heater unit 12 increasing the pure water in temperature (or heating it) are connected thereto. The cleaner provides an operation similar to that of the cleaner previously described: after the substrate(s) are processed with the wet etching solution when they are cleaned with the cleaning solution, hydrogen water supply unit 11 mixes pure water with hydrogen gas to provide a cleaning solution and heater unit 12 controls the cleaning solution to have a desired temperature, and the cleaning solution is thus supplied and substrate(s) 6 are exposed to an ultrasonic wave to remove particles on substrate(s) 6. The dissolved gas's concentration, the ultrasonic wave's frequency and energy, and the cleaning solution's temperature are also set in ranges, respectively, that are similar to those described above.

Furthermore the present cleaner can provide ultrasonic cleaning using a cleaning solution formed of a solution of a mixture of a solution obtained by dissolving a gas in pure water and a wet etching solution. For example, a hydrogen gas-dissolved solution produced by hydrogen water supply unit 11 and ammonia and oxygenated water or a similar chemical supplied from a chemical supply unit 18 are mixed together in a wet etching solution mixer unit (a chemical mixer unit 17) and heated in heater unit 12 to a desired temperature to provide a cleaning solution which is in turn supplied to single processing bath 15 and the substrate(s) are exposed to an ultrasonic wave so that the substrate(s) can have their fine patterns undamaged while high particle removal performance can be achieved. In particular, the APM's etching and accordingly lifting-off effect and the ultrasonic wave's physical effect provide a synergy to more efficiently remove particles.

The present substrate cleaner in another manner is a substrate cleaner in a system processing wafers, one at a time, including: a unit supplying a wet etching solution to apply it to a single substrate while the substrate is spun; a unit supplying a cleaning solution to apply it to the substrate while the substrate is spun; and a dryer unit. The cleaning solution has a gas dissolved therein to have a degree of saturation of 60% to 100% at atmospheric pressure, and before the cleaning solution is applied to the spinning substrate, the cleaning solution is exposed to an ultrasonic wave having a frequency of at least 1 MHz and an energy of at most 10 W, preferably at most 5 W. Applying the wet etching solution to a substrate that is secured on a single stage while spinning the substrate, applying the cleaning solution to the substrate that is secured on the single stage while spinning the substrate, and drying the substrate that is secured on the single stage, are a manner preferable in that it can achieve more efficient cleaning.

More specifically, the substrate cleaner in the system processing wafers, one at a time, has a configuration, as shown in FIG. 7. This cleaner processes a substrate (or a wafer 21), one at a time, and includes a stage 23 holding wafer 21 (or a substrate), a motor 24 rotating stage 23, a nozzle 10 jetting the wet etching solution to a surface of the substrate (wafer 21) that is to be processed, a nozzle 19 jetting the cleaning solution to the substrate, and a cleaning cup 22. Nozzle 19 has an ultrasonic wave oscillation plate (not shown) therein. Connected thereto are hydrogen water supply unit 11 receiving pure water from pure water supply unit 10, degassing the pure water, and mixing hydrogen gas generated by electrolysis of water into the degassed pure water, and heater unit 12 increasing the cleaning solution in temperature (or heating it). Note that generating hydrogen is not limited to electrolysis of water; hydrogen may be supplied externally from a cylinder (not shown). The process has a flow in which initially wafer 21(or a substrate) is secured on stage 23 and spun by motor 24 at a predetermined rate.

Then nozzle 10 jets the APM or a similar wet etching solution to apply it to the spinning substrate. Then a cleaning solution that has hydrogen gas mixed therein by hydrogen water supply unit 11 and is controlled by heater unit 12 to have a desired temperature is supplied to nozzle 19 and also exposed to an ultrasonic wave, and thus jetted to the spinning wafer 21 (or substrate) to remove particles on wafer 21 (or the substrate). Subsequently the substrate is spun fast and thus dried to complete a series of steps. Its basic function and effect are as has been described previously. The ultrasonic wave oscillation plate (or an oscillator) in nozzle 19 is different from that used in the processing bath for dipping: it provides an ultrasonic wave having a frequency of at least 1 MHz, and also includes those providing high frequencies of 1.5 MHz, 3 MHz, and the like. Higher frequency can reduce or prevent damage to finer patterns and also provide higher particle removal performance.

### EXAMPLES

### Example 1

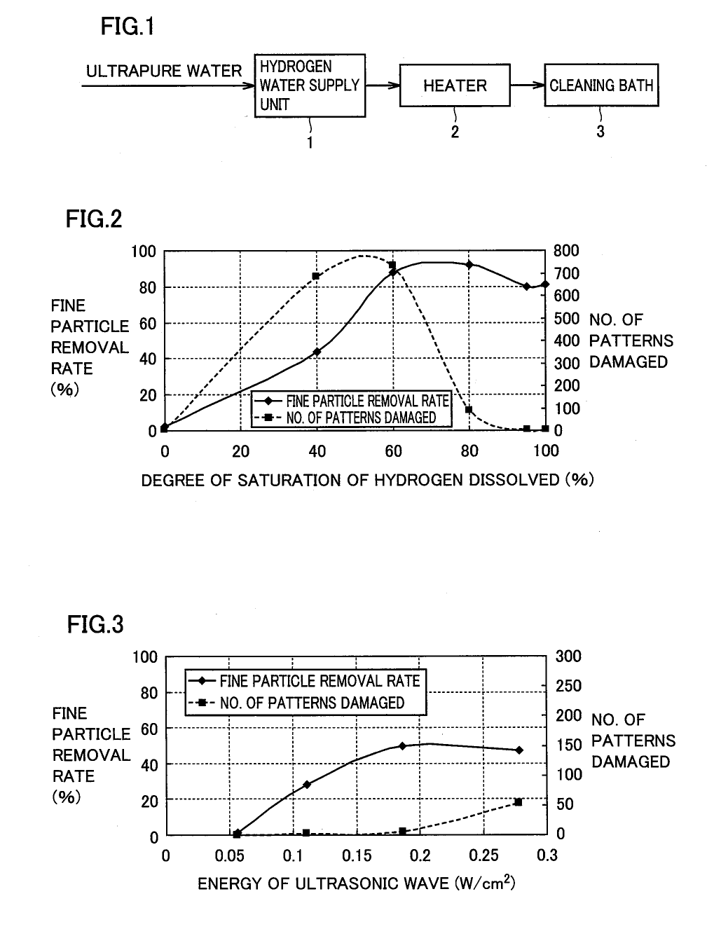

In the present example, it is examined how a degree of saturation of dissolved hydrogen in a cleaning method in a system processing a batch by dipping it affects efficiency in detergence (or fine particle removal rate) and how a fine pattern is damaged (or the number of fine patterns damaged). FIG. 1 is a schematic diagram showing a method of preparing a cleaning solution. As shown in FIG. 1, ultrapure water is fed to a hydrogen water supply unit 1 and subsequently heated by a heater 2, as required, and thereafter delivered to a cleaning bath 3 at a flow rate of 7 L/min. Hydrogen water supply unit 1 is KHOW-HS10S produced by Kurita Water Industries Ltd. and a cleaning solution is prepared thereby to have hydrogen dissolved therein to have a predetermined concentration. Hydrogen water supply unit 1 uses hydrogen gas generated by electrolysis of water. Alternatively, a hydrogen cylinder or the like may be used to externally supply hydrogen. Furthermore, the ultrapure water is first degassed by hydrogen water supply unit 1 and thereafter the hydrogen gas is dissolved therein. The dissolved hydrogen's concentration is measured with a dissolved-hydrogen concentration meter available from Orbisphere Laboratories. The cleaning solution prepared by hydrogen water supply unit 1 is adjusted by heater 2 to 70° C. Cleaning bath 3 is a dipping, ultrasonic cleaning bath (FINE-SONIC) available from PRE-TECH CO., LTD, and an ultrasonic wave having a frequency of 750 kHz and an energy of 0.111 W/cm² is applied and substrates are thus cleaned for 3 minutes.

A pattern is evaluated for damage, as follows: A pattern of a polysilicon gate is used as an object to be cleaned, and an 8-inch substrate of Si having a pattern having a width of 55 nm and a height of 142 nm with a bottommost 2 nm forming a gate insulation film is used. The pattern is evaluated for damage with a defect inspection device available from KLA-Tencor Corporation by counting how may defects are caused. Fine-particle removal is evaluated as follows: An 8-inch silicon substrate has a surface oxidized with APM and is subsequently immersed in pure water having fine particles of SiO₂ mixed therein, and thereafter it is spun and thus dried for evaluation. Fine-particle removal is evaluated by measuring with a foreign-matter inspection device available from KLA-Tencor Corporation how many fine particles of at least 65 nm the substrate has adhering thereto before and after it is cleaned.

A resultant measurement is shown in Table 1, and from a result shown in Table 1, how a degree of saturation of hydrogen dissolved in the cleaning solution affects fine particle removal rate and the number of patterns damaged is shown in FIG. 2. As shown in FIG. 2, although it depends on the fine pattern's robustness, to remove fine particles while minimizing or preventing damage to the pattern, it has been found that dissolving hydrogen to have a degree of saturation of at least 60% is preferable, dissolving hydrogen to have a degree of saturation of at least 70% is more preferable, and dissolving hydrogen to have a degree of saturation of at least 80% is particularly preferable.

TABLE 1

| | Degree of Saturation | | | | | |
|---|---|---|---|---|---|---|
| | (%) of Dissolved Hydrogen | | | | | |
| | 0 | 40 | 60 | 80 | 95 | 100 |
| Fine Particle Removal Rate (%) | 2.4 | 44 | 87.8 | 92 | 79.8 | 81.1 |
| No. of Patterns Damaged | 4 | 685 | 732 | 86 | 2 | 5 |

### Example 2

In the present example is examined how an ultrasonic wave's energy affects fine particle removal rate and the number of patterns damaged. This is done similarly as done in example 1 except that hydrogen is dissolved to have a degree of saturation of 88%, a cleaning solution having a temperature of 23° C. is used, and an ultrasonic wave varying in energy is applied. A result thereof is shown in Table 2. Furthermore FIG. 3 shows how the ultrasonic wave's energy affects fine particle removal rate and the number of patterns damaged. As shown in FIG. 3, as the ultrasonic wave is increased in energy, fine particles are removed at an increased rate. However, more fine patterns are damaged, and it has thus been found that an ultrasonic wave having an energy in a range of 0.05 W/cm² to 0.2 W/cm² is more preferable.

TABLE 2

| | Energy of Ultrasonic Wave | | | |
|---|---|---|---|---|
| | (W/cm²) | | | |
| | 0.056 | 0.111 | 0.186 | 0.278 |
| Fine Particle Removal Rate (%) | 1.1 | 28.2 | 49.7 | 47 |
| No. of Patterns Damaged | 0 | 1 | 5 | 54 |

### Example 3

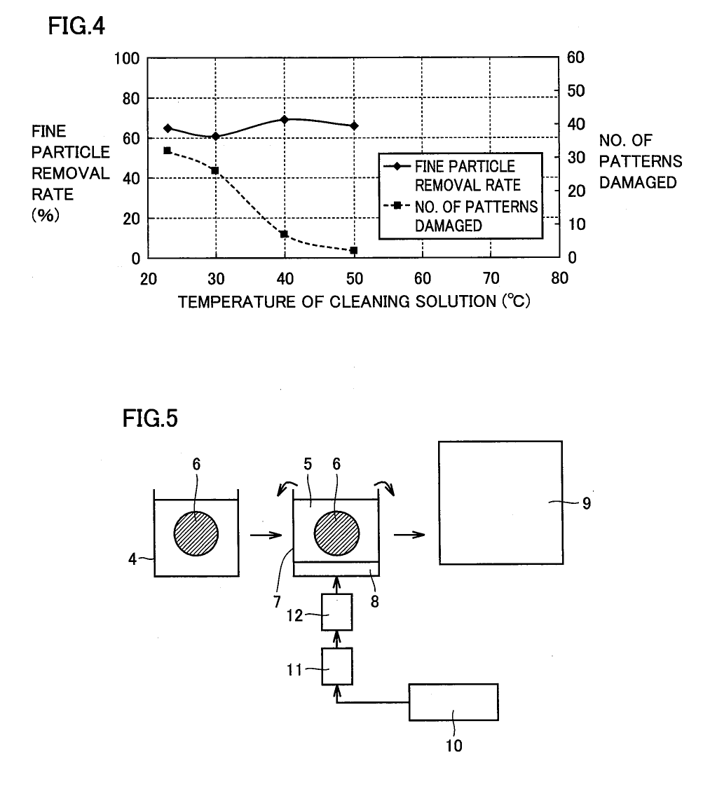

In the present example is examined how a cleaning solution's temperature affects fine particle removal rate and the number of patterns damaged. This is done similarly as done in example 1 except that hydrogen is dissolved to have a degree of saturation of 88%, and the cleaning solution is varied in temperature. FIG. 4 shows how the cleaning solution's temperature affects fine particle removal rate and the number of patterns damaged. As shown in FIG. 4, it has been found that as the cleaning solution is increased in temperature, fine particles are removed at a rate that does not change significantly, while less fine patterns are damaged.

As shown in FIG. 3, as the ultrasonic wave is increased in energy, fine particles are removed at an increased rate. However, more fine patterns are damaged. As shown in FIG. 4, as the cleaning solution is increased in temperature, fine particles are removed at a constantly high rate and less fine patterns are damaged. From these results, the cleaning solution is set at 50° C., hydrogen is dissolved to have a degree of saturation of 80% and an ultrasonic wave is set to have a frequency of 0.75 MHz and an energy of 0.1 W/cm², and a substrate having foreign matters adhering thereto and a microfabricated substrate are thus cleaned for 3 minutes. No pattern is damaged and fine particles of at least 65 nm can be removed at a high rate of 60%. Furthermore, the cleaning solution that is set at 60° C., hydrogen dissolved to have a degree of saturation of 95%, and the ultrasonic wave that is set to have an energy of 0.1 W/cm² provide a satisfactory result, i.e., no pattern is damaged and fine particles are removed at a high rate of 71%.

### Example 4

The present example provides cleaning in a condition similar to that of example 1 except that the cleaning solution has a temperature of 23 ° C., the dissolved hydrogen has a degree of saturation of 88%, and the ultrasonic wave has an energy of 0.1 W/cm². Fine particles are removed at a rate of 57% and 32 patterns are damaged.

### Comparative Example 1

Comparative example 1 provides cleaning in a condition similar to that of example 1 except that the cleaning solution has a temperature of 70° C., the dissolved hydrogen has a degree of saturation of 40%, and the ultrasonic wave has an energy of 0.1 W/cm². 680 patterns are damaged and fine particles are removed at a rate of 44%. A sufficient fine particle removal effect without causing damage cannot be achieved.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A method of cleaning one or more substrates in a system processing one or more substrates as one batch by dipping one or more substrates as one batch, comprising the steps of:
immersing one or more substrates as one batch in a wet etching solution;
ultrasonically cleaning said one or more substrates as said one batch; and
drying said one or more substrates as said one batch,
the step of ultrasonically cleaning employing a cleaning solution having a gas dissolved therein to have a degree of saturation of 60% to 100% at an atmospheric pressure, and an ultrasonic wave having a frequency of at least 500 kHz and an energy of 0.02 W/cm² to 0.5 W/cm².

2. The method of cleaning one or more substrates according to claim 1, wherein said ultrasonic wave has an energy of 0.05 W/cm² to 0.2 W/cm².

3. The method of cleaning one or more substrates according to claim 1, wherein said cleaning solution has a temperature of 30° C. to 90° C.

4. The method of cleaning one or more substrates according to claim 1, wherein said cleaning solution has a temperature of 40° C. to 80° C.

5. The method of cleaning one or more substrates according to claim 1, wherein said gas dissolved is at least one of: a gas selected from the group consisting of H₂, N₂, O₂ and CO₂; and a gaseous mixture of at least two thereof.

6. The method of cleaning one or more substrates according to claim 1, wherein said cleaning solution is a solution obtained by dissolving a gas in ultrapure water.

7. The method of cleaning one or more substrates according to claim 1, wherein said cleaning solution is a mixture of a solution obtained by dissolving a gas in ultrapure water and a wet etching solution.

8. The method of cleaning one or more substrates according to claim 1, wherein said one or more substrates are one or more semiconductor substrates having a fine pattern having a line width of at most 0.5 μm.

9. A substrate cleaner performing the method of cleaning one or more substrates according to claim 1.

10. The substrate cleaner according to claim 9, performing in a single container the steps of immersing one or more substrates as one batch in a wet etching solution and ultrasonically cleaning said one or more substrates as said one batch.

11. A method of cleaning substrates, one at a time, comprising the steps of:
applying a wet etching solution to a single substrate while spinning said substrate; applying a cleaning solution to said substrate while spinning said substrate; and drying said substrate, the step of applying said cleaning solution employing a cleaning solution having a gas dissolved therein to have a degree of saturation of 60% to 100% at an atmospheric pressure, said cleaning solution being exposed to an ultrasonic wave before the step of applying said cleaning solution, said ultrasonic wave having a frequency of at least 1 MHz and an energy of at most 10 W.

12. The method of cleaning substrates according to claim 11, wherein said ultrasonic wave has an energy of at most 5 W.

13. The method of cleaning substrates according to claim 11, wherein said cleaning solution has a temperature of 30° C. to 90° C.

14. The method of cleaning substrates according to claim 11, wherein said cleaning solution has a temperature of 40° C. to 80° C.

15. The method of cleaning substrates according to claim 11, wherein said gas dissolved is at least one of: a gas selected from the group consisting of H₂, N₂, O₂ and CO₂; and a gaseous mixture of at least two thereof.

16. The method of cleaning substrates according to claim 11, wherein said cleaning solution is a solution obtained by dissolving a gas in ultrapure water.

17. The method of cleaning substrates according to claim 11, wherein said cleaning solution is a mixture of a solution obtained by dissolving a gas in ultrapure water and a wet etching solution.

18. The method of cleaning substrates according to claim 11, wherein said one or more substrates are one or more semiconductor substrates having a fine pattern having a line width of at most 0.5 μm.

19. A substrate cleaner performing the method of cleaning substrates according to claim 11.

20. The substrate cleaner according to claim 19, performing the steps of applying a wet etching solution to a single substrate while spinning said substrate, applying a cleaning solution to said substrate while spinning said substrate, and drying said substrate, said substrate being secured on a single stage throughout the steps of applying said wet etching solution, applying said cleaning solution, and drying.
